(19) United States
(12) Patent Application Publication
(10) Pub. No.: US 2023/0131761 A1
(43) Pub. Date: Apr. 27, 2023

(54) METHOD FOR CONTROLLING AN AT LEAST PARTIALLY AUTONOMOUSLY DRIVING EGO VEHICLE

(71) Applicant: AVL LIST GMBH, Graz (AT)

(72) Inventor: Andreas Haydl, Wettmannstätten (AT)

(21) Appl. No.: 17/914,509

(22) PCT Filed: Mar. 24, 2021
(86) PCT No.: PCT/AT2021/060097

§ 371 Date: Sep. 26, 2022

(30) Foreign Application Priority Data
Mar. 25, 2020 (AT) A 50247/2020

(51) Int. Cl. B60W 60/00; B60W 40/105; B60W 30/18; B60W 40/04

(52) U.S. Cl. CPC B60W 60/0015; B60W 40/105; B60W 30/18163; B60W 40/04; B60W 2420/42; B60W 2420/52; B60W 2420/54; B60W 2554/4041; B60W 2554/406; B60W 2555/60; B60W 2720/106

(57) ABSTRACT

The invention relates to a method for controlling an at least partially autonomously driving ego vehicle, at least the surroundings, legal driving conditions and the traffic in front of the ego vehicle in a current lane being detected by sensors. The problem addressed by the invention is that of providing an improved method. The problem is solved in that a first query relating to a possible speed is carried out, and a target acceleration is calculated when it is detected that the possible speed is greater than the current speed, and a second query is carried out as to whether there is a vehicle in an adjacent lane within an observation region, whether an acceleration at the calculated target acceleration is carried out, since no vehicle has been detected within the observation region, or whether no acceleration at the target acceleration is carried out, since a vehicle has been detected within the observation region.

The invention relates to a method for controlling an at least partially autonomously driving ego vehicle, wherein at least the surroundings, legal driving conditions and the traffic in front of the ego vehicle in a current lane are detected by sensors. Furthermore, the invention relates to an associated vehicle for carrying out the method.

DE 10 2014 200 896 A1 describes a driving assistance system for changing lanes when merging into a lane. Sensors detect a partner vehicle which is assumed to show consideration for the driver's ego vehicle. This consideration, the braking process of the partner vehicle or a lane change process of this vehicle to clear the desired lane for the own lane change process is included for this lane change process. The required acceleration is calculated and set, or the vehicle continues to operate at constant speed if a lane change is not possible.

However, this consideration of the actions of other road users with regard to changing lanes is dangerous and can increasingly lead to accidents, because not every road user drives using all their available concentration. The increasing number of opportunities for distraction in the vehicle lead more and more often to dangerous traffic situations. Driving on a highway, in particular, is an invitation to divert one's attention away from road traffic to cell phones and the like. Although the use of cell phones while driving a vehicle is prohibited, accident statistics tell a different story.

Due to the possible distraction, the driver of the partner vehicle does not see the ego vehicle entering the highway or driving in the right lane. However, the control system now accelerates and initiates the lane change process. However, the partner vehicle now does not brake and a collision can no longer be prevented.

It is an object of the present invention to disclose an improved method and an associated improved ego vehicle.

This is solved by the above method according to the invention by performing a first query about a possible speed. When it is detected that the possible speed is greater than the current speed, a target acceleration is calculated. In addition, a second query is performed as to whether there is a vehicle in an adjacent lane in an observation region, whether either an acceleration is performed with the calculated target acceleration because no vehicle has been detected within the observation region, or whether no acceleration is performed with the target acceleration because a vehicle has been detected within the observation region.

The possible speed results, for example, from factors such as the road surface, the legally permitted maximum speed and/or the course of the road. In an advantageous design of the invention, for example, the possible speed for driving on serpentine roads is not the legally permitted maximum speed for driving on rural roads, but a reduced speed that ensures driving stability and a high level of safety.

An observation region is defined here as an area to the left or right of the ego vehicle in the direction of travel. This includes an area to the left or right in front of the ego vehicle and/or an area to the left or right behind the ego vehicle. The observation region is that region which is recorded by sensors of the ego vehicle for carrying out the method according to the invention.

These sensors are used to detect a vehicle in an adjacent lane. The alternatives left and right in the direction of travel of the ego vehicle are distinguished because there are legal requirements that prohibit acceleration of the ego vehicle during an overtaking maneuver by a partner vehicle. In Austria, for example, an overtaking maneuver is defined as passing a slower vehicle to the left of the slower vehicle. This therefore applies primarily in countries with right-hand traffic. In countries with left-hand traffic, the reverse is applicable.

Sensors detect the surroundings, the legal driving conditions and/or the traffic in front of the ego vehicle in a current lane and record it during the first query. Speed limits and the highest permissible speed, for example, are registered and stored in a memory. With this data stored in the memory, a computing unit determines what the highest permissible speed is. Based on the appearance of the course of the road, it is also possible to determine what speed would be possible to maintain the required level of safety. Furthermore, it is observed whether a road user in the current lane immediately in front of the ego vehicle is slower or faster than the ego vehicle. In this way, the first query determines whether it is possible to increase the speed while maintaining the current lane and then calculates the target acceleration when it is detected that the possible speed is greater than the current speed.

The second query is used to determine whether there is a vehicle in an adjacent lane within the observation region. For this purpose, the recording of the observation region by the sensors is evaluated and a decision is made as to whether a vehicle is present within the observation region. If the question about the vehicle in the neighboring lane within the observation region is answered in the affirmative by the computing unit, then no acceleration is carried out despite a possible higher speed in order to increase traffic safety. This measure enables an overtaking process of a vehicle in an adjacent lane to be completed more quickly. This also reduces times spent in the blind spot. This can be life-saving, especially for drivers of smaller vehicles, such as motorcyclists.

If no vehicle is detected within the observation region during the second query, safe acceleration is possible without invoking dangerous traffic situations. Therefore, acceleration is performed with the target acceleration. This procedure additionally complies with the legal requirement, for example in the Austrian Road Traffic Regulations, that acceleration is prohibited if the ego vehicle is currently being overtaken by another vehicle.

There is therefore increased safety due to the prohibition of acceleration when another vehicle is detected within the observation region. Another positive effect is that the autonomous or partially autonomous ego vehicle can be operated in accordance with the applicable traffic regulations.

The object according to the invention is further solved by an ego vehicle which is suitable and used for carrying out the above method.

It is particularly favorable if the observation region extends more than 25 m laterally along the ego vehicle in the left-hand direction of travel or in the right-hand direction of travel. This has the advantage of achieving a favorable compromise between safety by recording the surroundings as generously as possible and low storage requirements. In addition, the positive effect is further increased if the observation region extends more than 25 m diagonally to the left or diagonally to the right behind a rear edge of the ego vehicle in the direction of travel.

It is also advantageous if the observation region extends more than 25 m diagonally left or diagonally right in front of a leading edge of the ego vehicle in the direction of travel.

Depending on the situation, the ratio of required data volume to achieved safety can be optimized if the observation region is a region that is arranged laterally to the left or laterally to the right of the vehicle in the direction of travel, wherein the maximum extension of the observation region is dependent on the permitted, the possible and/or the current speed and/or the speed of the vehicle, and becomes larger with increasing speed.

Since the observation region behind the ego vehicle is particularly important for the process of overtaking the ego vehicle, it is especially advantageous if the extension of the observation region behind a rear edge of the ego vehicle depends on the difference between, on the one hand, the speed of the vehicle and, on the other hand, the possible or the current speed of the ego vehicle, and becomes larger as the difference increases.

It is favorable if the second query as to whether vehicles are present to the side comprises the recording of the observation region to the side of the vehicle by at least one sensor. The sensor can be provided separately for this purpose only or can be used additionally for this function. Thus, the sensor can detect only the observation region or can additionally detect an area outside the observation region, for example behind the observation region, in order to detect the position and speed of a vehicle that is outside the observation region. In comparison with the current speed of the ego vehicle, it can thus be determined whether and in what time the vehicle still outside the observation region will overtake the ego vehicle and is thus within the dynamically adjusted observation region at the start of the overtaking process.

It is particularly favorable if the sensor uses ultrasound, radar, a camera recording and/or laser scanning to record the observation region to the side of the vehicle. It has been found that these various technologies are particularly suitable for recording the environment in automotive engineering, since the required installation space and weight are small and these sensors are becoming increasingly inexpensive to procure.

In a particularly advantageous design of the method according to the invention, it is provided that the at least one sensor is part of a lane change assistant and preferably the evaluation software of the lane change assistant is used for the first query. A lane change assistant is also understood to be the term blind spot assistant, which is used practically synonymously. For this purpose, the lane change assistant also records the observation region to the side of the vehicle and determines whether a vehicle is present within the observation region. The lane change assistant usually issues a warning when a lane change is desired if a vehicle is in the so-called blind spot in the desired adjacent lane.

In order to obtain a method perfectly adapted to the ambient conditions, it is advantageously provided that the first query is performed again after a certain period of time, wherein the certain period of time corresponds in particular to 100 milliseconds.

Alternatively or additionally, it may be provided that the second query is performed again after a certain period of time, wherein the certain period of time corresponds in particular to 100 milliseconds.

In order to also make an overtaking maneuver pleasant and safe for the passengers, it is advantageous if at least one vehicle driving ahead in the current lane is detected and picked up by sensors and an overtaking maneuver is initiated and a target acceleration for carrying out the overtaking maneuver is calculated.

For this purpose, it is favorable if overtaking prohibitions are recognized and stored in the memory and the control system acts accordingly.

In Austria, for example, there is the exception that overtaking is also permitted on the right in traffic in the local area in the sense that the lane may be freely selected if there are at least two separate lanes in the same direction of travel. Therefore, it is favorable that the vehicle distinguishes between local area and open country and also recognizes the existing lanes and the control system acts accordingly and allows or prohibits acceleration.

A distinction between convoy traffic and unobstructed traffic can also be provided in a favorable variant of the method.

The invention is further explained with reference to the non-limiting figures, wherein:

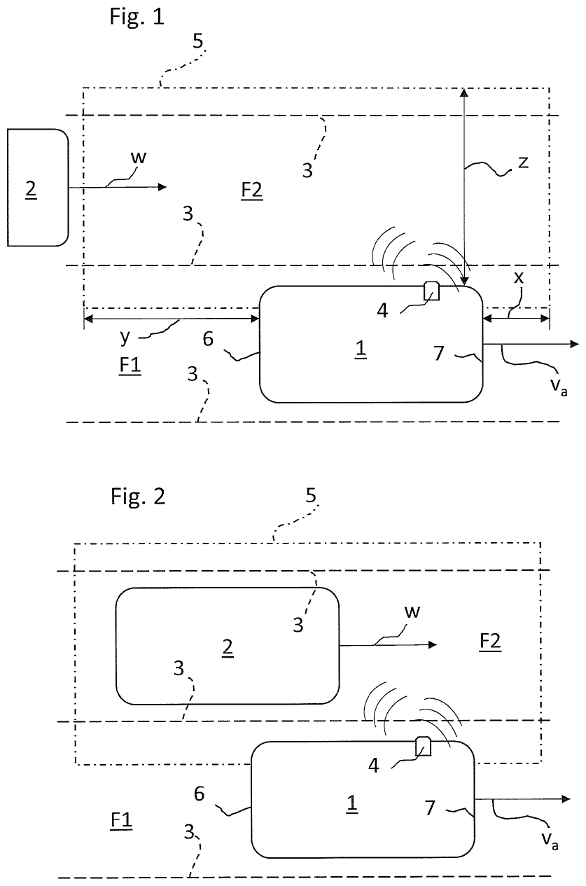

FIG. 1 shows a sketch of an ego vehicle according to the invention in road traffic in a first situation;

FIG. 2 shows a sketch of the ego vehicle according to the invention in road traffic in a second situation;

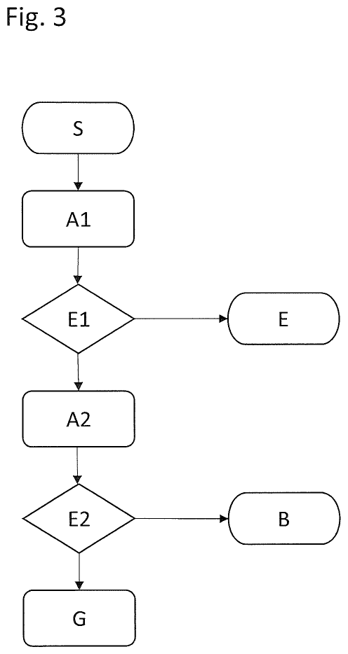

FIG. 3 shows a schematic sequence of a first embodiment of a method according to the invention; and

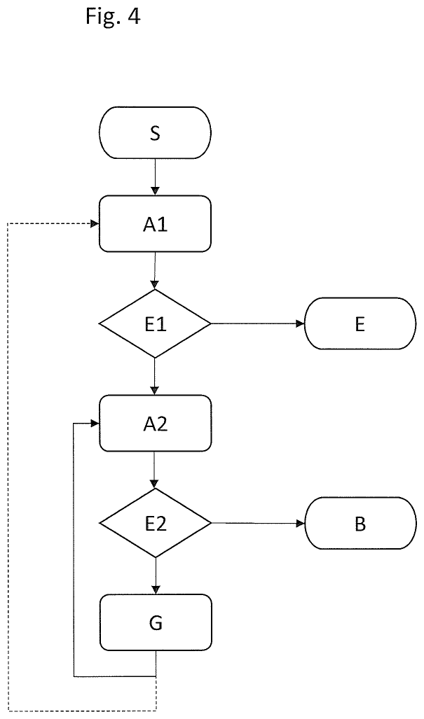

FIG. 4. shows a schematic sequence of a second embodiment of a method according to the invention.

FIG. 1 shows a first situation in which a method according to the invention is applied to an ego vehicle 1. Here, an ego vehicle 1 is traveling on a current lane F1 at a current speed vₐ. A vehicle 2 is traveling on an adjacent lane F2 at a speed w. At the moment shown, the two vehicles have the same direction of travel along the speed vectors vₐ and w. A line 3 is arranged between the current lane F1 and the neighboring lane F2 for demarcation. Lines 3 are also provided to delimit lanes F1, F2 from the surrounding area. The vehicle 2 moves on the adjacent lane F2 in the direction of travel to the left of the ego vehicle 1. The ego vehicle 1 has at least one sensor 4 which picks up an observation region 5 to the side of the ego vehicle 1. In the embodiment shown, the observation region 5 is located to the left of the ego vehicle 1 in the direction of travel. Here, the observation region 5 extends 25 m laterally along the ego vehicle 1 in the left direction of travel, wherein in this exemplary embodiment the extension y behind a rear edge 6 of the ego vehicle 1 is greater than the extension x in front of a front edge 7 of the ego vehicle 1. In the direction transverse to the direction of travel, the observation region 5 extends over a distance z which preferably exceeds the adjacent lane F2, i.e. in particular is 1.75 times the lane width, if the sensor 4 is arranged centrally on the ego vehicle 1. If the sensor 4 is arranged laterally on the ego vehicle 1, 1.25 times the lane width is sufficient to reliably detect whether a vehicle is in the lane F2. In an advantageous design, the observation region 5 extends in the direction of travel about 25 m to the left behind a rear edge 6 and about 5 m in front of a front edge 7 of the ego vehicle 1. In a particularly advantageous design, the observation region 5 is selected dynamically as a function of the current speed vₐ of the ego vehicle 1, the current speed w of the vehicle 2 and/or a difference between the current speed w of the vehicle 2 and the current speed vₐ of the ego vehicle 1.

In FIG. 1, the vehicle 2 is outside the observation region 5. In contrast, FIG. 2 shows a second situation in which the vehicle 2 is inside the observation region 5. This means that the sensor 4 of the ego vehicle 1 perceives the vehicle 2. In the first situation according to FIG. 1, the vehicle 2 is also in a position with respect to the ego vehicle 1, in which the ego vehicle 1 can determine the position and speed w of the vehicle 2, although the vehicle 2 is outside the observation region 5 according to the invention. This is carried out by the sensor 4 or another sensor of the ego vehicle 1.

In particular, the two situations in FIG. 1 and FIG. 2 represent successive situations. Here, the speed of the vehicle 2 is greater than the speed of the ego vehicle 1, so that the vehicle 2, coming from behind, catches up with the ego vehicle 1 and thus drives into the observation region 5.

Alternatively, two situations may arise in which the spatial distance in the direction of travel between the vehicle 2 and the ego vehicle 1 remains unchanged, but the speed of one of the vehicles or of both vehicles changes in such a way that the observation region 5 of the method according to the invention extends so much more to the rear in the second situation that the vehicle 2 is now within the observation region 5. In particular, the difference between the current speed w of the vehicle 2 and the current speed vₐ of the ego vehicle 1 or the difference between the current speed w of the vehicle 2 and the determined possible speed vₘ of the ego vehicle 1 can be used here to determine the observation region 5. In both cases, the observation region 5 is determined according to the invention in such a way that an overtaking process of the vehicle 2 is detected at the ego vehicle 1 and the vehicle 2 is located within the observation region 5, in particular within the extension y behind a rear edge 6 of the ego vehicle 1. The overtaking process still takes place if the vehicle 2 is located next to the ego vehicle 1 or in the extension x in front of a front edge 7 of the ego vehicle 1, so that the observation region 5 is selected according to the invention so that the vehicle 2 is located within the observation region 5 during the overtaking process. Thus, if no vehicle 2 is located within the observation region 5, no overtaking process is currently taking place. Thus, according to the invention, the observation region 5 can be selected on the one hand statically with, for example, 25 m behind a rear edge 6 and 5 m in front of a front edge 7 of the ego vehicle 1 or, on the other hand, dynamically as a function of the current speed vₐ of the ego vehicle 1, the current speed w of the vehicle 2 and/or a difference between the current speed w of the vehicle 2 and the current speed vₐ of the ego vehicle 1.

FIG. 3 shows a schematic process flow. Here, S indicates the start of the method according to the invention. From the recordings of the sensors of the ego vehicle 1, knowledge about the surroundings of the ego vehicle 1, in particular the road conditions, the legally permitted maximum speed and the course of the road, the position and the speed w of the vehicle 2, as well as the current speed vₐ of the ego vehicle 1 is stored in the memory. Thus, current restrictions and prohibitions as well as the positions and speeds of the vehicle 2 and the ego vehicle 1 are stored and can be retrieved for the method.

The method starts with a first query A1. For this purpose, a possible speed vₘ is determined. The possible speed vₘ depends on the road conditions, the legal possibilities, the traffic in front of the ego vehicle 1 and possibly the driver's wish. After determining the possible speed vₘ, a first decision E1 is made as to whether the possible speed vₘ is greater or less than the current speed vₐ. If the current speed vₐ is less, a target acceleration is determined with the determined possible speed vₘ and the method is continued with a second query A2.

When the actual speed vₐ is greater than the determined possible speed vₘ an end E of the method is reached.

In the second query A2, it is determined whether a vehicle 2 is present in an adjacent lane F2 within the observation region 5. A decision E2 is made about it and an acceleration B with the calculated target acceleration is performed if no vehicle 2 is detected within the observation region 5 and no acceleration B with the target acceleration is performed if a vehicle 2 is detected within the observation region 5. In that case, the speed in step G is kept constant.

In contrast to this, in FIG. 4 the method is continued again with the first query A1 or with the second query A2 after a certain period of time.

1. A method for controlling an at least partially autonomously driving ego vehicle, wherein at least the surroundings, legal driving conditions and the traffic in front of the ego vehicle in a current lane are detected by sensors, wherein
a. a first query is carried out about a change in a current speed of the ego vehicle to a possible speed of the ego vehicle, while maintaining the current lane and a target acceleration is calculated when it is detected that the possible speed is greater than the current speed, and
b. a second query is carried out as to whether a vehicle is located on an adjacent lane within an observation region, whether either an acceleration is carried out with the calculated target acceleration because no vehicle was detected within the observation region or whether no acceleration is carried out with the target acceleration because a vehicle was detected within the observation region.

2. The method of claim 1, wherein the observation region extends more than 25 meters (m) laterally along the ego vehicle in the left direction of travel or in the right direction of travel.

3. The method of claim 1, wherein the observation region extends in the direction of travel more than 25 m obliquely to the left or right behind a rear edge of the ego vehicle.

4. The method of claim 1, wherein the observation region extends more than 25 m obliquely to the left or right, in front of a leading edge of the ego vehicle in the direction of travel.

5. The method of claim 1, wherein the observation region is a region which is arranged laterally to the left or right of the ego vehicle in the direction of travel, wherein a maximum extension of the observation region is dependent on the permitted, the possible speed and/or the current speed of the ego vehicle and/or the speed of the vehicle and becomes greater with increasing speed.

6. The method of claim 1, wherein an extension of the observation region behind a rear edge of the ego vehicle, is dependent on the difference between, on the one hand, the speed of the vehicle and, on the other hand, the possible speed or the current speed of the ego vehicle and becomes greater as the difference increases.

7. The method of claim 1, wherein a recording of the observation region laterally of the ego vehicle is made by at least one sensor.

8. The method of claim 7, wherein the at least one sensor records the observation region laterally of the ego vehicle with ultrasound, with radar, with a camera recording and/or with laser scanning.

9. The method of claim 7, wherein the at least one sensor is part of a lane change assistant, wherein the lane change assistant includes computer-executable instructions, executable by a processor to perform the first query.

10. The method of claim 1, characterized in that the first query is performed again after a certain period of time, wherein the certain period of time corresponds in particular to 100 milliseconds.

11. The method of claim 1, wherein the second query is performed again after a certain period of time, wherein the certain period of time corresponds in particular to 100 milliseconds.

12. The method of claim 1, wherein at least one vehicle driving ahead in the current lane is detected and picked up by sensors and an overtaking maneuver is initiated and a target acceleration for carrying out the overtaking maneuver is calculated.
